(19) United States
(12) Patent Application Publication
(10) Pub. No.: US 2015/0257369 A1
(43) Pub. Date: Sep. 17, 2015

(54) Multi-Activity Dog Leash Connector

(71) Applicant: Matthijs van Leeuwen, Redmond, WA (US)

(72) Inventor: Matthijs van Leeuwen, Redmond, WA (US)

(21) Appl. No.: 14/214,685

(22) Filed: Mar. 15, 2014

(51) Int. Cl. A01K 27/00; A44B 13/02

(52) U.S. Cl. CPC A01K 27/003; A44B 13/02

(57) ABSTRACT

A multi-activity dog leash connector comprising of a carabiner, a bungee cord which is being connected in a first loop position onto the carabiner, a cap which covers the portion where said bungee cord is connected to the carabiner, a loop-locker positioned onto the bungee cord to prevent squeezing of a second loop, wherein said cap facilitates the operation of the carabiner in taking in and out a dog leash from the carabiner and the second bungee loop is connected to a person and other objects thereby allowing a pet and a person to exercise together while keeping the person's hands free for doing other activities.

### FIELD OF THE INVENTION

The present invention is related to a device and a method for training and exercising with domestic animals. More particularly, the invention relates to a device and a method wherein the device can be attached to a person or an object whereby domestic animals, more specifically dogs, can participate in and join the exercise or training activity along with the person or object.

### BACKGROUND OF THE INVENTION

The health of a pet depends on several factors. One very important factor is exercise. Exercise helps the pet keep its muscles and joints in good condition, and keep its body fat at a healthy level. Unfortunately, many pets do not get the amount of exercise that they need. This is often a result of pet owners having a schedule that takes up the majority of their time, thereby leaving little time for playing with or exercising their pets. Household pets such as dogs and cats are generally confined indoors and spend a majority of their time sleeping except when let out once or twice a day or taken for an occasional walk as in the case of dogs. This schedule may suit some breeds of dogs and cats while others need a more vigorous exercise routine to help them expend their excess built up energies and manage their destructive behavior. They need training and exercise on a daily basis and usually multiple times a day.

As human beings generally have busy lives and need time for their exercise activities as well, there is a need for a device that allows the owner to combine both owner and pet exercise activities. The importance of exercise for the general well being of these pets has necessitated the need for the development of a device that allows owner to combine both owner and pet exercise activities.

There are a number of devices known in prior art for the exercise of pets. There are also a number of devices known for the exercise of dogs. Conventionally such devices are pet toys and exercise devices and balls and these prior art devices are generally adequate for allowing a pet to have exercise under the supervision of its owner. So, when the owner is not able to make out time the pet is deprived of exercise.

U.S. Pat. No. 6,192,835 shows a hands-free pet leash system that allows hands-free use, both when the animal is connected to the leash and when the animal is unleashed. The system comprises a waist belt, a leash, and a collar adapter/connector, which cooperate with each other to provide easy, quick-connection/disconnection of the dog from the leash, the leash from the belt, and the belt from the person wearing it. But, in this system, the pet owner must wear the waist belt all the time to stay connected to the pet animal through the leash. Also, the leash can only be connected to a person wearing the waist belt and not to any other object. Moreover, the system leashes the pet to the person or has the pet unleashed. U.S. Pat. No. 5,842,445 discloses an apparatus for attaching a pet leash to a bicycle having a generally v-shaped bar comprising two legs and a radiused apex. A connector is attached to two ends of the bar opposite the apex and is adapted for connection to a front of a bicycle above a front tire. A clasp is configured to freely slide along the bar and to releasably and securely attach to a pet leash. The reference fails to provide a method of attaching the dog leash to an object other than a bicycle. Since this system necessitates fixing a special arrangement to a bicycle, the pet owner must always use the bicycle to make the pet exercise with him or her. U.S. Pat. No. 5,161,846 discloses a device for the restraint of an animal accompanying a person as that person is walking or jogging. The device provides for two-point attachment of a leash to the person's waist and permits the person to restrain a leashed animal while at the same time leaving the person's hands and arms free to swing. The device comprises a waistband system and a modified animal lead. This device can be connected only to the waist of a person. U.S. Pat. No. 5,080,045 discloses a device for use by a person in walking or jogging while leaving both hands free which is made up of a belt encircling the jogger's waist, a suspension ring in outer spaced surrounding relation to the belt and flexibly suspended downwardly and away from the belt so as to loosely encircle the hip region, and a leash extends from the ring for attachment to a dog and has an end connector which is slidable around the full circumferential extent of the ring while being free to rotate about its own axis to avoid twisting or snarling of the leash. This invention can be connected only to the waist of a person.

U.S. Patent Application No. US20130042818A1 discloses a waist-belt including retractably controllable pet leash for freeing a user's hand when walking or running with a dog, with means coupled with the belt to attach to, and allow, carrying of a grocery or shopping bag, a pocketbook, or water bottle at the same time, and with controllable front and rear manners of illumination to provide visualized warnings and detection of such activities safely during both daytime and night time hours. This device can only be attached to the waist of a person. U.S. Patent Application No. 20120067297A1 discloses a hands-free device for restraining and controlling pets (mostly dogs) and small children. The user wears the device at the hips below the waistline adjusting hip belt at his/her convenience. By connecting the end of the hands-free retractable leash lead to a dog collar, or a child's harness, user is ready for walking. This device can be connected only at the hips below the waistline.

Consequently, there exists in the art a long-felt need for a device that will allow a person in performing combined exercise with his or her dog in a very convenient manner. There also exists in the art a long felt need for a device which is simple in design and can connect a pet to different parts of a person or to an object such that the person can keep his or her hands free while exercising with his or her dog. Additionally, there is a long felt need in the art for a device that allows a person to save his time without having to allot extra time to his or her pet exercise. Finally, there is a long-felt need for a device that is simple in design, relatively inexpensive to manufacture, and safe and easy to use.

### OBJECTS OF THE INVENTION

It is an object of the invention to provide a dog leash connector that can be used for pet exercise combined with exercise of its owner.

Another object of the invention is to provide a dog leash connector that is easier to use for exercise of dogs combined with its owner's exercise thereby saving extra time that is required to allot for pet exercise as in the prior art systems.

A still another object of the invention is to provide a dog leash connector that can be connected to a person and to any other object.

Yet another object of the invention is to provide a dog leash connector that can get most handgrips of dog leashes through.

A further object of the invention is to provide a dog leash connector that provides a cuff at the portion of connection of the dog leash connector and the wearer for providing comfort to the wearer.

A still further object of the invention is to provide a dog leash connector that securely connects a dog to a person.

A still another object of the invention is to provide a dog leash connector that facilitates the lunge absorbing function.

Yet another object of the invention is to provide a dog leash connector that can firmly be connected to a person and to any other object.

A still another object of the invention is to provide dog leash connector that allows the person to keep his hands free for doing other activities.

These and other objects of the invention will be apparent from the ensuing description.

### BRIEF SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, is a dog leash connector, hereinafter referred to as a multi-activity dog leash connector comprising of a carabiner, a bungee cord, a loop-locker, a cap and a cuff. The loop-locker further comprising of a lower part and an upper part, inside ribs, first opening and a top opening is a type of clip which is made of hard plastic or any other suitable material. The carabiner is a type of hook with a spring loaded gate that is used to quickly and reversely connect components.

Accordingly, there is provided a multi-activity dog leash connector comprising a carabiner having a closed end opening, a bungee cord which is being connected in a first loop position onto said carabiner, a cap which covers the connecting portion of said carabiner and said bungee cord. The bungee cord of the first loop is placed on the first opening of the loop-locker, and, by clicking the upper and lower parts together, the loop-locker is positioned firmly onto the bungee cord. The first loop is then taken through the top opening of the loop-locker and then pulling the carabiner through the opening of the first loop results in the formation of the second loop. The position of the loop-locker determines the size of the second loop which can be adjusted according to need by repositioning the loop-locker. Said cap facilitates the operation of the multi-activity dog leash connector in taking in and out said dog leash from the carabiner and said second bungee loop is connected to a person and other objects thereby allowing a pet and said person to exercise together. A cuff, which is a soft padding positioned on the second loop, makes looping around human body parts more convenient and provides comfort to the wearer and the loop-locker prevents the second loop from squeezing against any pull. The bungee cord absorbs lunges from the dog. The present invention allows the pet owner to combine both dog and human exercise needs. It allows the user to place the dog leash into the carabiner and free up the owner's hands for use in other activities, including exercising. The elasticity of the bungee cord controls the impact of any unexpected stops or jerks caused by the dog and when the owner connects it to the wrist, bicep or waist, s/he still will be able to easily take over the leash when necessary. Examples of looping the second bungee loop of the bungee cord of this device are a person's belt, wrist, bicep or a child stroller or a bicycle. The present invention securely connects a dog to a person.

Consequently, the device of the present invention enables a person to combine his or her exercise with his or her dog's exercise thereby saving time, and, at the same time allows the person to keep his or her hands free for other activities. Additionally, the device of the present invention is simple in design and relatively inexpensive to manufacture, and safe and easy to use.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a top view of an exemplary embodiment of the multi-activity dog leash connector with an open loop-locker in accordance with the present invention;

FIG. 2 is a cross sectional view highlighting the cap and the loop locker in accordance with the present invention;

FIG. 3 is a perspective view of an exemplary embodiment of the multi-activity dog leash connector in accordance with the present invention; and

FIG. 4 is a perspective view of the muliti-activity dog leash connector with gate of the carabiner in open position in accordance with the present invention.

FIG. 5A is a schematic view of an exemplary embodiment of the multi-activity dog leash connector, where the second bungee loop is connected to an object.

FIG. 5B is a schematic view of an exemplary embodiment of the multi-activity dog leash connector which shows the opening of the carabiner.

FIG. 5C is a schematic view of an exemplary embodiment of the multi-activity dog leash connector, where the second bungee loop is connected to a person's belt.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding thereof. It may be evident, however, that the invention can be practiced without these specific details.

The multi-activity dog leash connector of the present invention enables a person to combine his or her exercise with his or her dog's exercise thereby saving time and at the same time allow the person to keep his or her hands free for other activities. Finally, the device of the present invention is simple in design and relatively inexpensive to manufacture, and safe and easy to use.

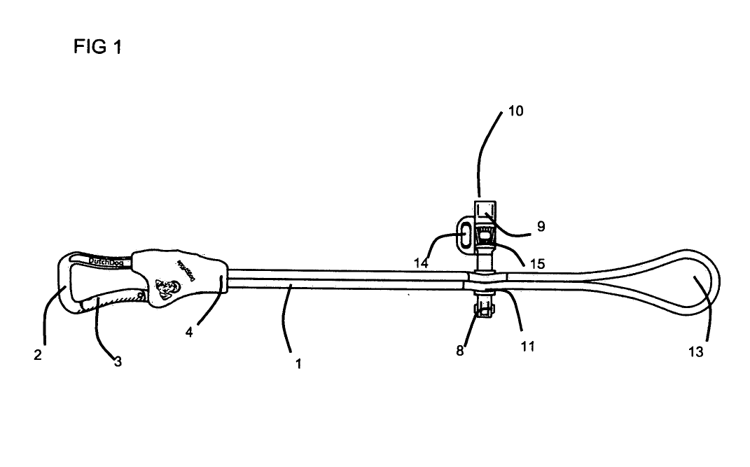

FIG. 1 illustrates a top view of a multi-activity dog leash connector of the present invention with a loop-locker 10 which is in an open state. The multi-activity dog leash connector comprising of a carabiner 2, a bungee cord 1, a first bungee loop 13, a loop-locker 10, and a cap 4 is illustrated in FIG. 1. The carabiner 2 further comprises of a spring loaded gate 3. The carabiner 2 has a gate opening in a bottom thumb shape to get handgrips of most dog leashes through. The carabiner 2 can be manufactured from metal or any other suitable material known in the art. The carabiner 2 can also be manufactured in a variety of sizes, colors, styles and designs to accommodate most handgrips of dog leashes. The carabiner 2 is used to quickly and reversibly connect components.

The loop-locker 10 is further comprised of a lower part 8, upper part 9, inside ribs 15, first opening 11 and a top opening 14 as illustrated in FIG. 1. The loop-locker 10 can be manufactured from hard plastic or any other suitable material known in the art. The loop-locker 10 can also be manufactured in a variety of sizes, colors, styles and designs.

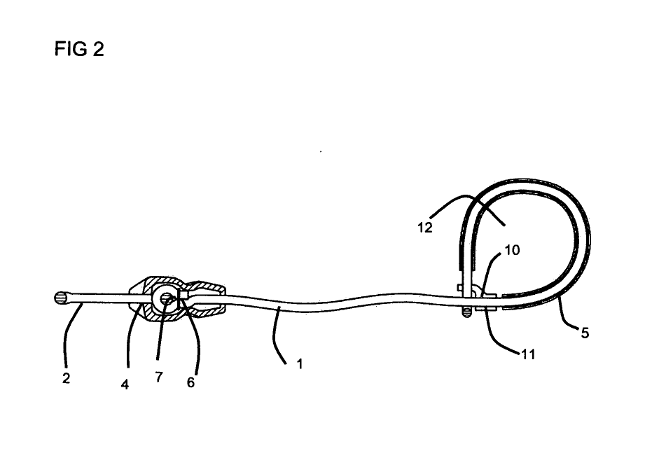

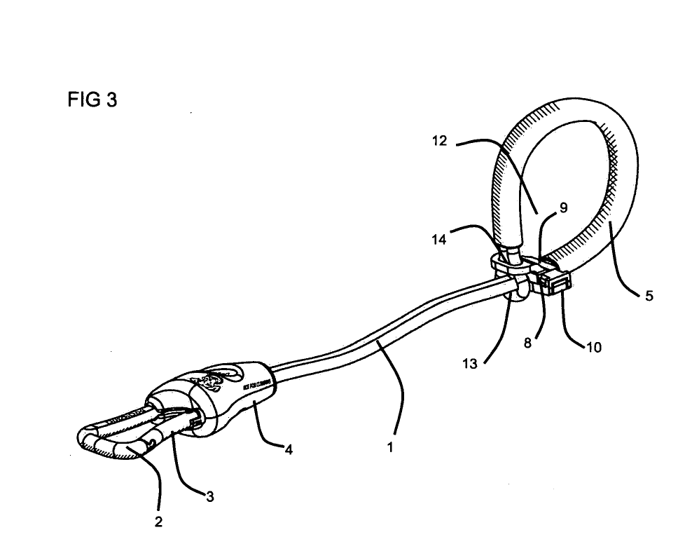

As illustrated in FIG. 1 and FIG. 2, a first bungee loop 13 is made by securing both the ends of the bungee cord 1 to the carabiner 2 with a wire 7.

As best illustrated in FIGS. 1 and 2, a cap 4 made of silicon or similar flexible material is slipped over the end of the bungee cord first loop 13, and permanently positioned at the portion where the ends of the bungee cord are connected to the carabiner 2.

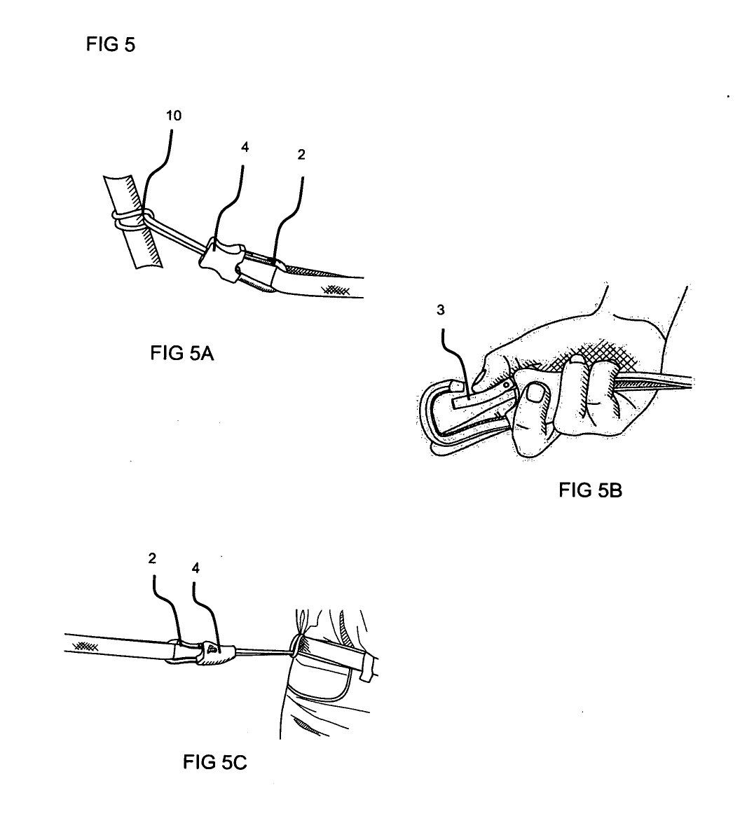

As best illustrated in FIG. 5B, the ergonomically designed cap 4 facilitates a user to easily take in or take out the handgrip of a dog leash to or from the carabiner 2.

As illustrated in FIGS. 1, the bungee cords of the first loop 13 is kept in the first opening 11 of the loop-locker 10 at a desired position. Then, by clicking the lower part 8 with the upper part 9, the loop-locker 10 is fixed onto the bungee cords. The curved shape of the first opening 11 along with the ribs 15 present therein ensure that the loop locker sits firmly on the bungee cords when the lower part 8 and the upper part 9 are clicked together. The end of the first bungee loop 13 is then taken through the top opening 14 of the loop-locker 10 and the carabiner 2 is then passed through the open end of the first loop 13. This results in the formation of the second loop 12 best illustrated in FIG. 2 with the position of the loop-locker 10 determining the beginning of the second loop 12. The size of the second loop 12 can be adjusted by placing the loop-locker 10 at different positions according to need. The second bungee loop 12 is connected to a person and other objects such as person's belt as best illustrated in FIG. 5C, bicep, wrist, child stroller and any part of a bicycle (not shown in figures). As the loop-locker 10 sits firmly onto the bungee cord, the second loop 12 will not get squeezed when pulled by the carabiner 2 as result of a lunge. The cuff 5 with soft padding fitted in the second loop 12 provides comfort to the wearer. The portion of the bungee cord between the loop-locker 10 and the cap 4 facilitates the lunge absorbing function.

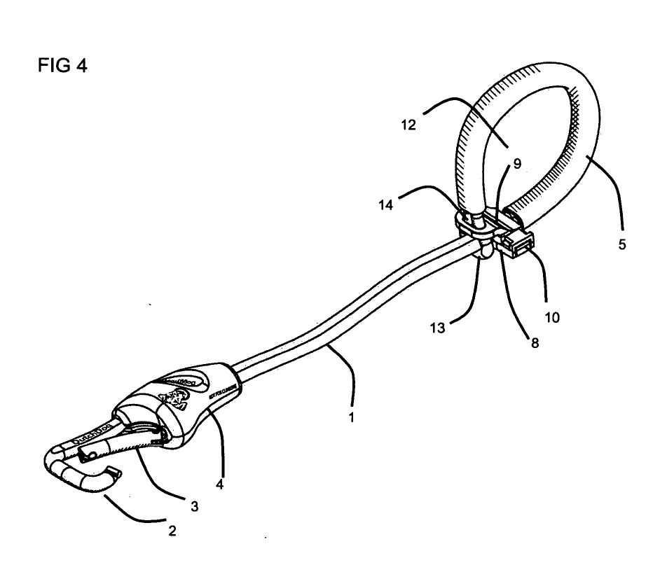

FIG. 4 shows a multi-activity dog leash connector with spring loaded gate 3 in an open position.

FIG. 5A and FIG. 5C illustrate a multi-activity dog leash connector which can be made to encompass an object or a person's belt.

In a preferred embodiment, a method of using a multi-activity dog leash connector for training and exercising activities of dogs comprises the steps of opening a carabiner of a multi-activity dog leash connector, attaching a handgrip of a dog leash into the carabiner, keeping a first loop of a bungee cord in a first opening of a loop locker, clicking a lower part and an upper part to place said loop locker firmly on the bungee cord, taking the first loop through a top opening of the loop-locker and passing the carabiner through an open end of the first loop thereby forming a second loop, wherein the second loop is made to encompass a person's body parts and an object such as a person's belt, wrist, child stroller and to any part of a bicycle. The dog leash is connected to a person using said multi-activity dog leash connector and a person and a dog can exercise together.

Additionally, other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” and “including,” are to be construed as open-ended terms (i.e., meaning “including, but not limited to,”) unless otherwise noted. The term “connected” is to be construed as partly or wholly contained within, attached to, or joined together, even if there is something intervening. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A multi-activity dog leash connector, comprising:
a carabiner having a closed end opening;
a bungee cord which is being connected in a first loop position onto said carabiner;
a cap which covers the portion where said bungee cord is connected to said carabiner;
a loop-locker positioned onto said bungee cord to prevent squeezing of a second loop;
wherein said cap facilitates the operation of said carabiner in taking in and out a dog leash from said carabiner and said second bungee loop is connected to a person and other objects thereby allowing a pet and said person to exercise together while keeping said person's hands free for doing other activities.

2. The multi-activity dog leash connector as in claim 1, wherein said carabiner has a gate opening in a bottom thumb shape to get handgrips of most dog leashes through.

3. The multi-activity dog leash connector as in claim 1, wherein a cuff in said second loop provides comfort to the wearer.

4. The multi-activity dog leash connector as in claim 1, wherein said second bungee loop is being looped around said person's belt, bicep and wrist.

5. The multi-activity dog leash connector as in claim 1, wherein said second bungee loop is being looped around a part of a child stroller.

6. The multi-activity dog leash connector as in claim 1, wherein said second bungee loop is being looped around a part of a bicycle.

7. The multi-activity dog leash connector as in claim 1, wherein said bungee cord absorbs lunges from the dog.

8. The multi-activity dog leash connector as in claim 1, wherein said loop-locker further comprises of a lower part, an upper part, a first opening, a top opening and inside ribs.

9. The multi-activity dog leash connector as in claim 1, wherein said multi-activity dog leash connector securely connects a dog to said person.

10. A method of using a multi-activity dog leash connector for training and exercising activities of dogs, said method comprising:
opening a carabiner of said multi-activity dog leash connector;
attaching a handgrip of a dog leash into said carabiner;
keeping a first loop of a bungee cord in a first opening of a loop locker;
clicking a lower part and an upper part to place said loop locker firmly on said bungee cord;
taking said first loop through a top opening of said loop-locker; and
passing said carabiner through an open end of said first loop thereby forming a second loop;
wherein said second loop is made to encompass a person's body parts and an object whereby a dog leash is connected to said person using said multi-activity dog leash connector and said person and said dog can exercise together.

11. The method of using a multi-activity dog leash connector for training and exercising activities of dogs as in claim 9, further comprises looping said second bungee loop around a person's bicep and a person's belt.

12. The method of using a multi-activity dog leash connector for training and exercising activities of dogs as in claim 9, further comprises looping said second bungee loop around a part of a child stroller.

13. The method of using a multi-activity dog leash connector for training and exercising activities of dogs as in claim 9, further comprises looping said second bungee loop around a part of a bicycle.

14. The method of using a multi-activity dog leash connector for training and exercising activities of dogs as in claim 9, further comprises attaching securely said handgrip of said dog leash inside said carabiner.

15. The method of using a multi-activity dog leash connector for training and exercising activities of dogs as in claim 9, said loop-locker further comprises of a lower part, an upper part, a first opening, a top opening and inside ribs.
